(19) United States
(12) Patent Application Publication
(10) Pub. No.: US 2013/0003109 A1
(43) Pub. Date: Jan. 3, 2013

(54) METHOD, APPARATUS, AND COMPUTER READABLE STORAGE MEDIUM FOR COMMUNICATING WITH A PRINTER

(76) Inventor: Ryan R. KILEY, Penfield, NY (US)

(21) Appl. No.: 13/173,980

(22) Filed: Jun. 30, 2011

(51) Int. Cl. G06F 3/12

(52) U.S. Cl. 358/1.15

(57) ABSTRACT

A non-transitory computer readable storage medium encoded with instructions, which when executed by a computer causes the computer to implement a method including: generating a first graphical user interface providing links to content stored locally on the computer and to content accessed via Internet; and generating a second graphical user interface that identifies a printer that the computer is configured to communicate with, and that provides links to an interface for ordering parts or supplies for the printer and an interface to place a service request for the printer.

### TECHNOLOGICAL FIELD

The present application describes an apparatus that communicates with a printer. Associated methods and a computer readable storage medium are also described

### BACKGROUND

Service of production printers conventionally requires a technician to visit the production printer. The technician would arrive only having the customer's description of the problem. The technician may have to spend hours diagnosing the problem and may have to consult with a remote service department. In some cases, the technician would need to communicate information to the service department, leave, and return at later time to perform a repair. When the production printer is down the customer's print shop may suffer from inefficiencies resulting in the loss of income.

### SUMMARY

A non-transitory computer readable storage medium encoded with instructions, which when executed by a computer causes the computer to implement a method including: generating a first graphical user interface providing links to content stored locally on the computer and to content accessed via Internet; and generating a second graphical user interface that identifies a printer that the computer is configured to communicate with and obtain diagnostic information from, and that provides links to an interface for ordering parts or supplies for the printer and an interface to place a service request for the printer.

A method including: generating, by computer, a first graphical user interface providing links to content stored locally on the computer and to content accessed via Internet; and generating, by the computer, a second graphical user interface that identifies a printer that the computer is configured to communicate with and obtain diagnostic information from, and that provides links to an interface for ordering parts or supplies for the printer and an interface to place a service request for the printer.

An apparatus including: a memory that stores computer executable instructions; and a processor configured to execute the instructions in order to generate a first graphical user interface providing links to content stored locally on the apparatus and to content accessed via Internet, and generate a second graphical user interface that identifies a printer that the computer is configured to communicate with and obtain diagnostic information from, and that provides links to an interface for ordering parts or supplies for the printer and an interface to place a service request for the printer.

### BRIEF DESCRIPTION OF THE DRAWINGS

A more complete appreciation of the exemplary embodiments described herein and many of the attendant advantages thereof will be readily obtained as the same becomes better understood by reference to the following detailed description when considered in connection with the accompanying drawings, wherein:

FIGS. 1A-C show examples of computing devices upon which embodiments described herein may be implemented upon;

FIG. 2 shows an example of hardware included in the devices of FIGS. 1A-C;

FIG. 3 shows an example of a system that may be used with embodiments described herein;

FIG. 4 shows an example of a production printer;

FIG. 5 shows an example of a graphical user interface;

FIG. 6 shows an example of a graphical user interface;

FIG. 7 shows an example of a graphical user interface;

FIG. 8 shows an example of a graphical user interface;

FIG. 9 shows a method of communicating with a production printer; and

FIG. 10 shows an example of metrics that may be obtain in regards to a production printer.

### DETAILED DESCRIPTION

Referring now to the drawings, wherein like reference numerals designate identical or corresponding parts throughout the several views.

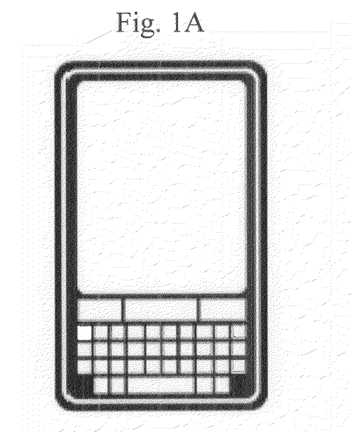

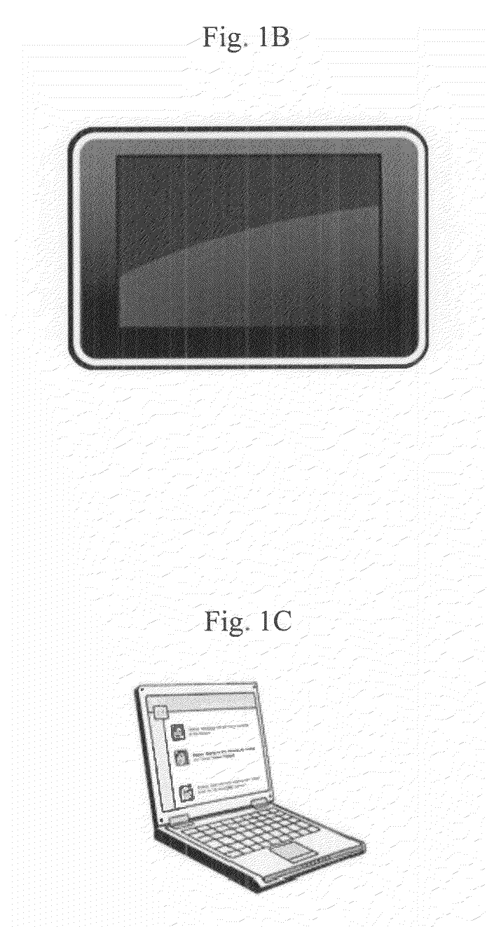

FIGS. 1A-C show examples of computing devices upon which embodiments described herein may be implemented upon. FIG. 1A shows a cell phone or Smartphone. Cell phones of Smartphones operating with Apples' software, Microsoft's software, RIM's Blackberry® software, or Google's Android® software may be used. These are merely examples, and other cell phone/software combinations may be used. FIG. 1B shows a tablet computer device, such as an IPad®. Again, other tablet/software combinations may be used. FIG. 1C shows a computer, which may operate with Apple's operating system, Microsoft's Windows ®, Google's Android®, Linux, or other operating system software.

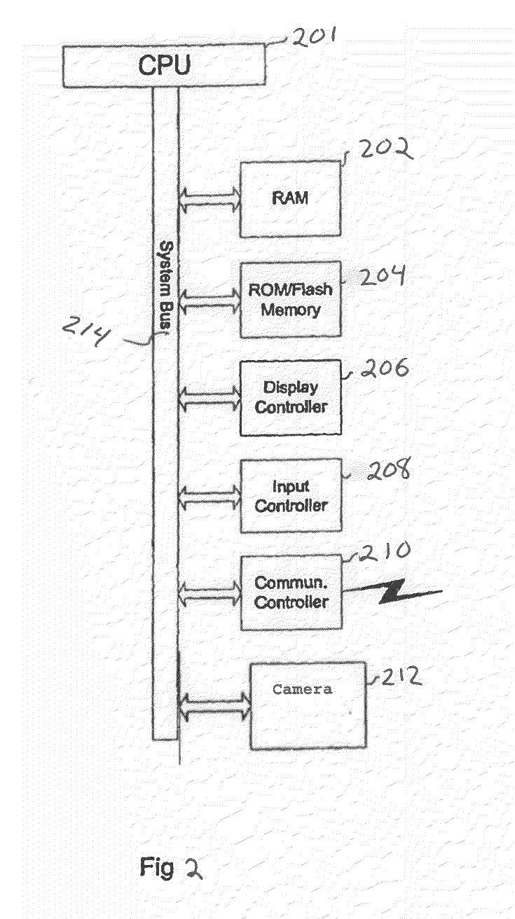

FIG. 2 shows a block diagram of the hardware that may be found in the devices of FIGS. 1A-C. The devices in FIGS. 1A-C include, for example, CPU 201, RAM 202, ROM 204, display controller 206, input controller 208, communications controller 210, and camera 212. The various hardware units are interconnected by way of system bus 214. The CPU 201 processes instructions or sequences of instructions stored in the RAM 202 and/or ROM 204 in response to input commands of a user via input controller 208. The display controller controls the display of images and text on the display in response to commands from the CPU 201. Communications controller 210 allows the device to receive and process wireless digital data from a production printer and/or other electronic devices on the wireless LAN. The communication controller 210 may also provide access to the Internet. Communications controller 210 may communicate with 3G protocols, 4G protocols, bluetooth, or wi-fi. It is to be understood that the items in the block diagram of FIG. 2 are exemplary items intended to provide exemplary hardware in the devices of FIG. 1A-C. The device of FIG. 2 may incorporate any of the components of a known wireless computing device such as Apples' IPod®, IPad®, netbooks, laptops, or desktop computers.

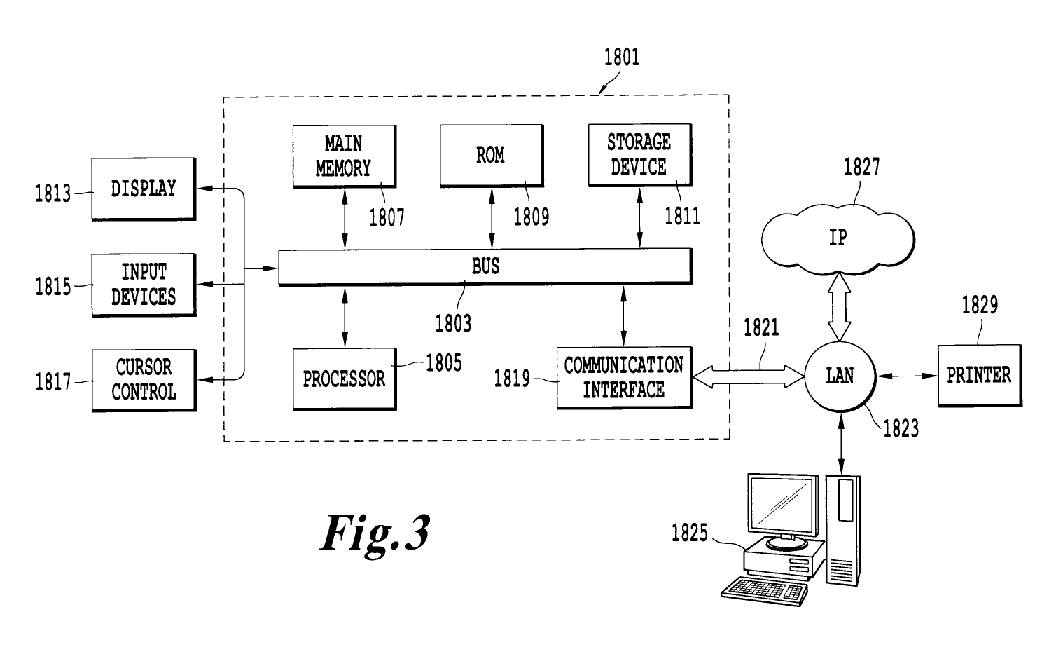

FIG. 3 illustrates an alternative portable computer system 1801 upon which an embodiment described herein may be implemented. Computer system 1801 includes a bus 1803 or other communication mechanism for communicating information, and a processor 1805 coupled with bus 1803 for processing the information. The processor 1105 may be implemented as any type of processor including commercially available microprocessors from companies such as Intel, AMD, Motorola, Hitachi and NEC.

The computer system 1801 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or fixed, high density media drives, may be added to the computer system 1801 using an appropriate device bus (e.g., a small computer system interface (SCSI) bus, an enhanced integrated device electronics (IDE) bus, or an ultra-direct memory access (DMA) bus). The computer system 1801 may additionally include a compact disc reader, a compact disc reader-writer unit, or a compact disc juke box, each of which may be connected to the same device bus or another device bus.

Computer system 1801 may be coupled via bus 1803 to a display 1813, such as a cathode ray tube (CRT), LED display, or LCD display, for displaying information to a computer user. The display 1813 may be controlled by a display or graphics card. The computer system may include input devices, such as a keyboard 1815 and a cursor control 1817, for communicating information and command selections to processor 1805. The cursor control 1817, for example, is a mouse, a trackball, or cursor direction keys for communicating direction information and command selections to processor 1805 and for controlling cursor movement on the display 1813. Alternatively, the input device may include a touch screen.

The computer system 1801 performs a portion or all of the processing steps in response to processor 1805 executing one or more sequences of one or more instructions contained in a memory, such as the main memory 1807. Such instructions may be read into the main memory 1807 from another computer-readable medium, such as storage device 1811. One or more processors in a multi-processing arrangement may also be employed to execute the sequences of instructions contained in main memory 1807. In alternative embodiments, hard-wired circuitry may be used in place of or in combination with software instructions. Thus, embodiments are not limited to any specific combination of hardware circuitry and software.

As stated above, the system 1801 includes at least one computer readable medium or memory programmed according to the teachings described herein and for containing data structures, tables, records, or other data described herein. Stored on any one or on a combination of computer readable media, the exemplary embodiments described herein include software for controlling the computer system 1801, for driving a device or devices, and for enabling the computer system 1801 to interact with a human user, e.g., a customer. Such software may include, but is not limited to, device drivers, operating systems, development tools, and applications software.

The computer code devices used in the exemplary embodiments described herein may be any interpreted or executable code mechanism, including but not limited to scripts, interpreters, dynamic link libraries, Java classes, and complete executable programs.

The term “computer readable medium” as used herein refers to any medium that participates in providing instructions to processor 1805 for execution. A computer readable medium may take many forms, including but not limited to, non-volatile media, volatile media, and transmission media. Non-volatile media includes, for example, optical, magnetic disks, and magneto-optical disks, such as storage device 1811. Volatile media includes dynamic memory, such as main memory 1807. Transmission media includes coaxial cables, copper wire and fiber optics, including the wires that comprise bus 1803. Transmission media also may also take the form of acoustic or light waves, such as those generated during radio wave and infrared data communications. Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave, or any other medium from which a computer can read.

Various forms of computer readable media may be involved in carrying out one or more sequences of one or more instructions to processor 1805 for execution. For example, the instructions may initially be carried on a magnetic disk of a remote computer. The remote computer can load the instructions for implementing all or a portion of the embodiments described herein remotely into a dynamic memory and send the instructions over the Internet. Bus 1803 carries the data to main memory 1807, from which processor 1805 retrieves and executes the instructions. The instructions received by main memory 1807 may optionally be stored on storage device 1811 either before or after execution by processor 1805.

Computer system 1801 also includes a communication interface 1819 coupled to bus 1803. Communication interface 1819 provides a two-way data communication coupling to a network link 1821 that is connected to a local network (e.g., LAN 1823). For example, communication interface 1819 may be a network interface card to attach to any packet switched local area network (LAN). As another example, communication interface 1819 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 1819 sends and receives electrical, electromagnetic or optical signals that carry digital data streams representing various types of information. The radio waves may be implemented using a spread spectrum technique such as Code Division Multiple Access (CDMA) communication or using a frequency hopping technique such as that disclosed in the Bluetooth specification previously described.

Network link 1821 typically provides data communication through one or more networks to other data devices. For example, network link 1821 may provide a connection through LAN 1823 to a computer 1825, to a production printer 1829, or to data equipment operated by a service provider (i.e., a service center), which provides data communication services through an IP (Internet Protocol) network 1827 (e.g., the Internet 607). LAN 1823 and IP network 1827 both use electrical, electromagnetic or optical signals that carry digital data streams. The signals through the various networks and the signals on network link 1821 and through communication interface 1819, which carry the digital data to and from computer system 1801, are exemplary forms of carrier waves transporting the information. Computer system 1801 can transmit notifications and receive data, including program code, through the network(s), network link 1821 and communication interface 1819.

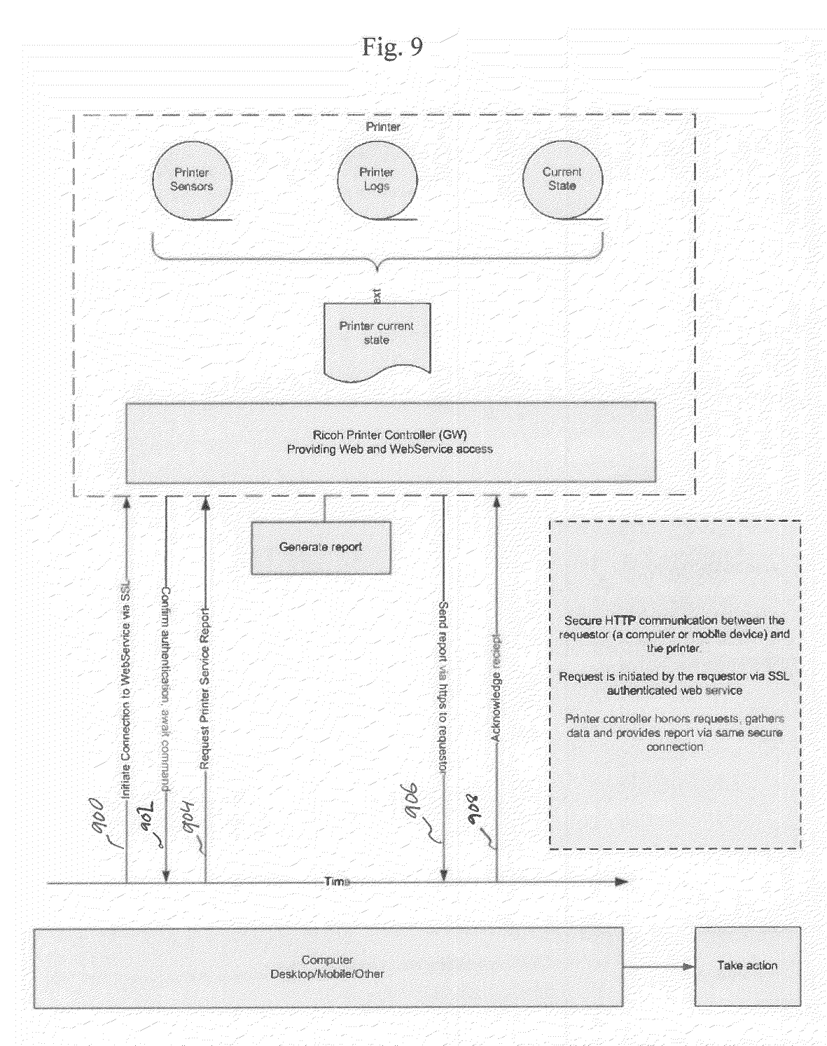

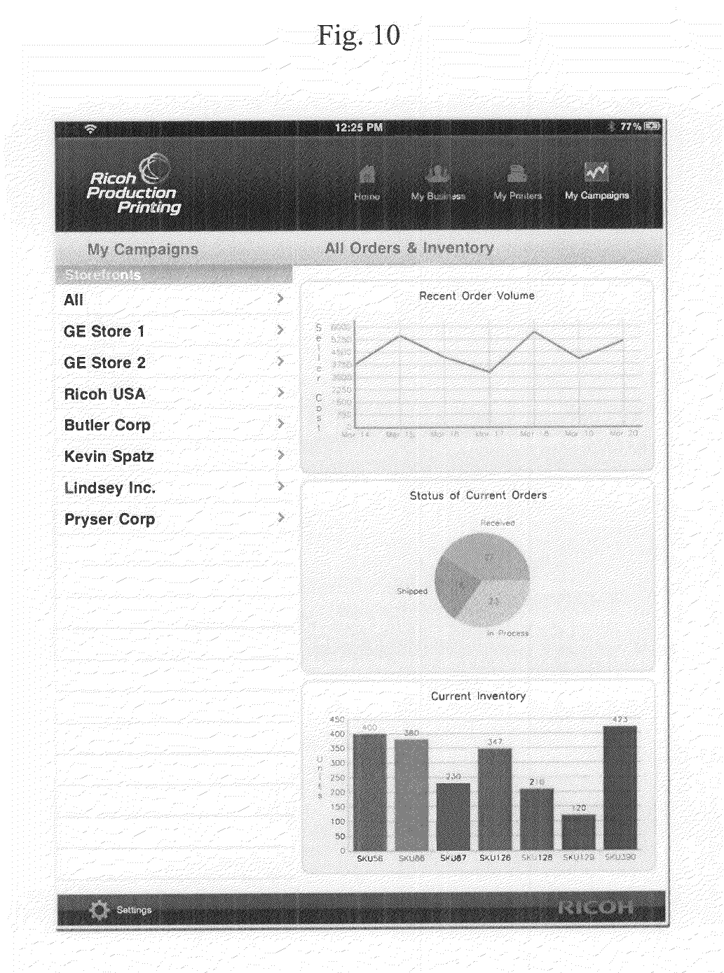

Embodiments described herein may be of interest to a print shop. A print shop is a printing company that prints the orders received from customers (i.e., print campaigns) using printers. A campaign as defined herein is a connected series of operations designed to bring about a particular result. More particularly, a campaign generally relates to the process of disseminating personalized information intended to persuade an end recipient of such information to take a particular action to acquire, purchase, lease, hire, or the like, the products and/or goods and/or services provided by a customer of the print shop (i.e., the Advertising Agency). Such products, and/or goods and/or services may be in the form of samples thereof or notification of availability of services on a sample basis. FIGS. 9 and 10 of U.S. Patent Publication 2009/0313060 illustrate an exemplary campaign item. U.S. Patent Publication 2009/0313060 is incorporated herein by reference in its entirety.

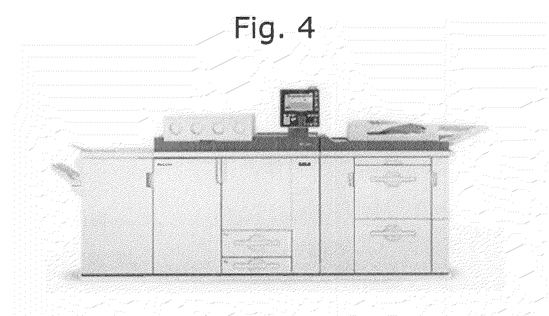

Printers that may be used in a print shop include, but are not limited to, laser printers, printing presses, digital copiers, book making machines, facsimile machines, or a multifunction machine that performs print outputting function. An example of a production printer used by a print shop is the Ricoh C900, an image of which is shown in FIG. 4.

In an exemplary embodiment, devices shown in FIGS. 1A-C, 2, and 3 are programmed via software to provide the functionality described below. When executed on mobile device (e.g., cell phone, smart phone, or tablet), such software is referred to as an “app.” The exemplary app described below may be used as a business development tool for the owners/operators of production printing devices, or a marketing service provided for print shops (hereinafter referred to as “customers”). The app may be used to increase profits by leveraging business development tools contained within the app, and/or accessed through the app. For example, two areas of business development may be addressed by the app: (1) increase sales by offering, demonstrating and proving the effectiveness of more advanced print/software/labor services; and (2) increase operational efficiency, thereby reducing costs.

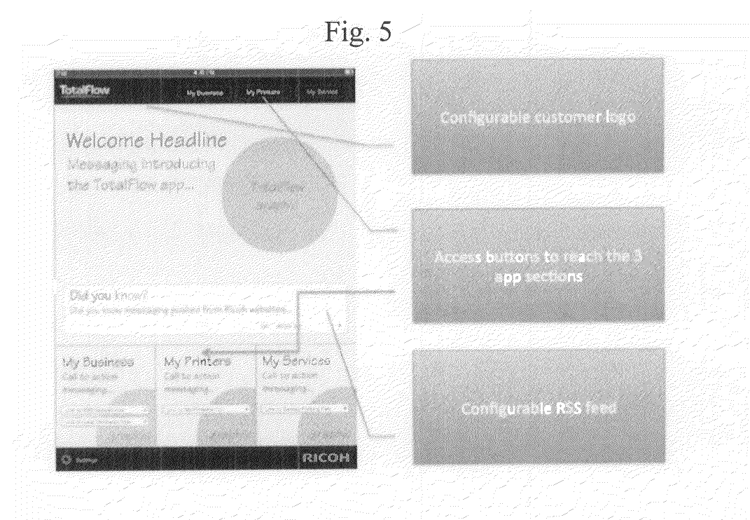

FIG. 5 shows an exemplary home screen that is first displayed when the app is launched. The home screen displays a configurable customer logo. The customer may select an image file from the computing device's image library to brand the experience for their company. A distributor of the app may require that their logo remain displayed on the app in conjunction with the customer's logo. The home screen may include the following navigation buttons: my business 510, my printers 512, and my services 514. The home screen may include display area 516 for displaying an RSS (really simple syndication) feed, which may display frequently updated works—such as blog entries, news headlines, audio, and video—in a standardized format. The app may include subscriptions to predetermined RSS feeds, which may promote services offered by the app's distributor. Alternatively, the customer may select the RSS feeds themselves.

My Business

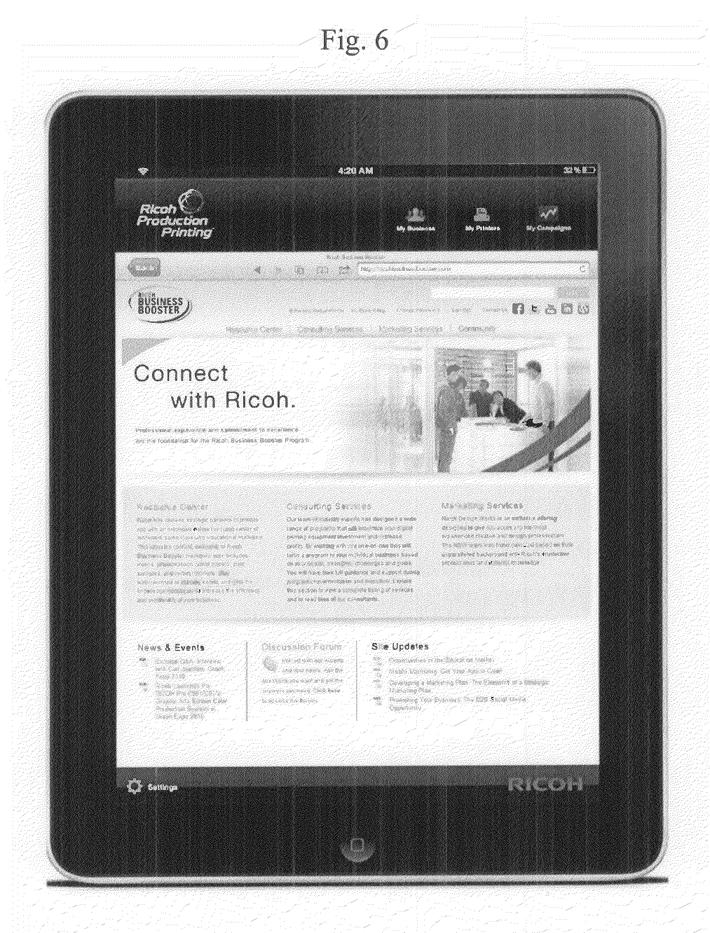

The my business access button 510, when selected, causes the menu screen shown in FIG. 6 to be displayed. The menu screen in FIG. 6 is merely an example, and other formats may be used. The menu screen in FIG. 6 provides an extensible marketing gallery. The App's distributor may provide an updateable list of available products and/or services that the customer may use to promote their business. The business of a print shop, for example, may be better promoted if the print shop may show their customers that they utilize the latest technology in binding equipment, for example. The App, through the my business menu, may provide access to industry news, product analysis, and/or whitepapers on technology driving customer success. The my business menu may provide access to a discussion forum where various customers may discuss various issues pertaining to the print shop business, such as equipment that is also distributed by the app's distributor. The my business menu may provide links to YouTube® content, or other video files and audio files on the Internet or other networks. The my business menu may provide links to presentations regarding technology the customer is employing in their print shops, which will help the customer market their services by providing tutorials on the technology used in the campaign (i.e., personal URLs (pURL) and QR codes). Some of the information provided through the my business menu may be stored locally on the device and other information may be obtainable through the Internet or from another network. Furthermore, the app's distributor may push files or information to the customer through the app. The customer may add items to the marketing gallery by inputting a URL that links to the item they wish to add. Alternatively, in desktop/laptop/netbook embodiments, the user may input a file path indicating where the item is store locally on the desktop/laptop/netbook. Any file type supported on the user's computing device for view/playback may be used.

My Printers

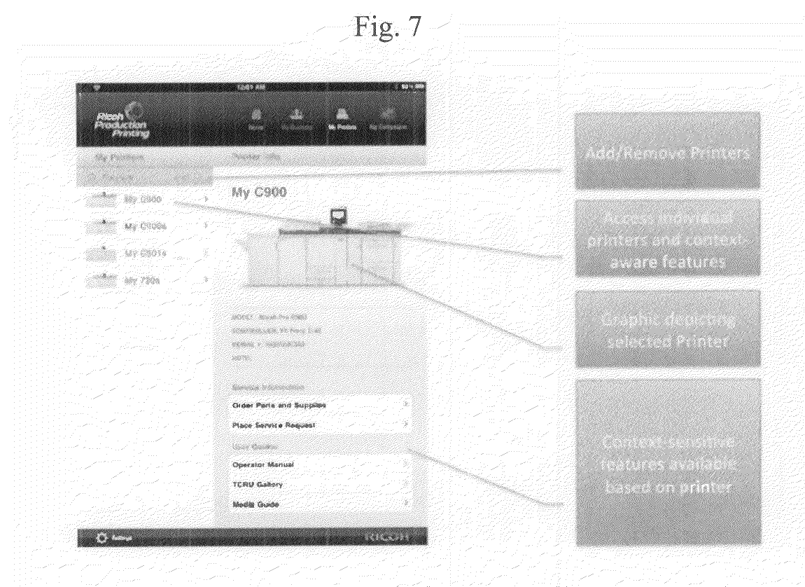

The my printers access button 512 allows for the customer to monitor the printers within their network. The customer may monitor whether their printers are online and operational, or are offline and require maintenance. FIG. 7 shows a menu screen corresponding to the my printers access button 512. The menu screen in FIG. 7 is merely an example, and other formats may be used. The menu screen in FIG. 7 shows current printers in the customer's system, provides a link to order parts and supplies, a link to place a service request, and links to user guides. With the functionality provided by the my printers access button, a customer's system downtime may be reduced, and the customer may receive faster, easier, and more accurate service responses that could not have been achieved previously.

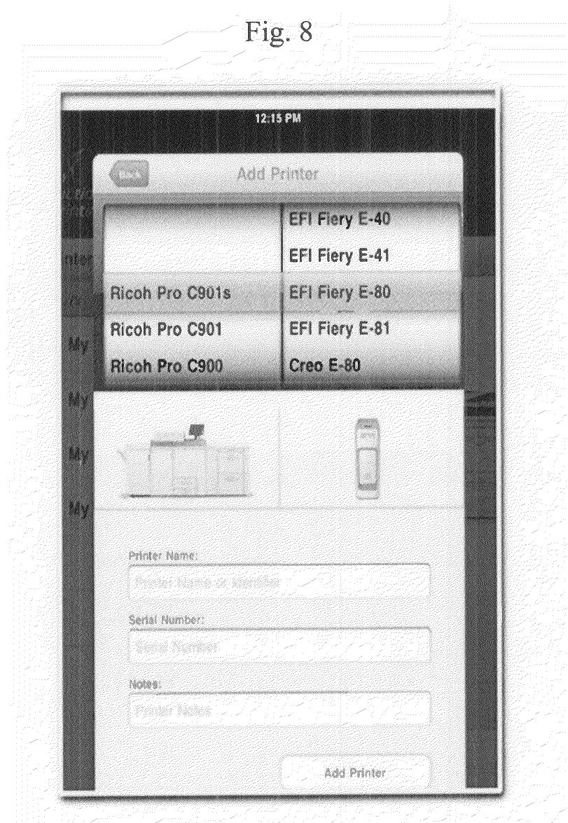

The customer may add and remove printers that are registered in the app at their discretion. The app may be preconfigured with supported production printers and accessories. FIG. 8 shows a menu screen used to add a printer to the my printers part of the app. Information captured through an add printer dialogue box in FIG. 8 includes printer serial number (may be used with a variety of communications with a service department) and printer IP address. This information may be stored by the app in the form of a database.

The app, through the my printers functionality, may provide context-sensitive functionality by displaying links for available materials and functions, including but not limited to, ordering parts and supplies, placing a service request, obtaining or reading an operation manual, accessing a TCRU gallery, and obtaining o reading a media guide.

To order supplies, the computing device will use the app and web browser to link to a website of the production printer provider. The website of the production printer provider will enable ordering of supplies and services. The server of the production printer provider may be configured to recognize the computing device of the customer by referring to a database correlating the customers unique ID number or IP address to their identity and/or service contract that defines entitlements that the customer may have (i.e., which parts and supplies they may need for their production printers, warranty information, terms of service contracts, etc.).

The menu screen in FIG. 7 provides a link so the customer may place a service request. Quality, on-time, service is critical to the customer's success. With instant access to place a service request, the app described herein provides a faster, mobile way for the customers to request assistance. The service request may be sent by the computing device in the form of an email or a text message. Alternatively, the computing device using the app and the device's web browser may link directly to a dedicated website that allows the customer to submit a written description of their problem. The customer, using any of these request submission options, may also submit files along with their request. Such files may include a diagnostic report from the printer, described in further detail below. Alternatively, when used on a computing device configured to make a phone call, the place service request option may connect the customer via phone to a service representative.

The app configures the computing device to communicate directly with the customer's production printers. FIG. 9 is a flow chart regarding communications between computing device with the app and a production printer. By allowing the customer to directly communicate with the production printer, more accurate, less costly service can be brought to bear on the customer's issues. The communication between the computing device with the app and the production printer may utilize a secure HTTP connection. In step 900, the computing device initiatives a connection to WebService via SSL. In step 902, the production printer confirms authentication of the computing device, and indicates that it is waiting for a command. The production printer includes a print controller that is able to communicate with the customer's computing device even when the production printer is otherwise experiencing mechanical problems. In step 904, the computing device requests the printer service report. In response thereto, the production printer's print controller creates the printer service report. The printer service report is not stored in the production printer and is created in response to the request from the computing device. The production printer determines status by obtaining diagnostic readings from various sensors included in the production printer, determining a current state of production printer, and obtaining production logs (including past performance of the production printer) and formatting this information into the printer service report. These sensors include, but are not limited to, sensors that determine the current state of the production printer (online, offline, error), sensors that measure temperature, sensors that measure pressure, sensors that measure humidity, sensors that measure the operation status of components within the printer, sensors that measure input speed, sensors that measure output speed, sensors that measure speed of belts and/or drums inside the production printer, sensors that measure paper level, sensors that measure toner level, sensors that monitor for paper jams, and sensors that measure/monitor any other adjustable setting of the production printer. In step 906, the production printer's print controller transfers the printer service report via HTTPS to the customer's computing device. In step 908, the customer's computing device transmits an acknowledgement message.

In the example of FIG. 9, the customer initiated the request for the service report. In an alternative embodiment, the production printer, in response to an error, may push the service report to the customer's computing device, which will provide the customer with a real time notification of an error in the production printing device. Furthermore, the printer may push to the customer's computing device with the app regarding warnings or critical conditions. Alternative, the customer may use the app to request a reading from any one of the sensors.

The customer may transmit this printer service report to a service center/representative when making a service request as described above. Thus, when addressing the service request, the service center/representative may have a detailed diagnostic report regarding the printer. When combined with the ability to monitor the status of the production printers, the customer can reduce downtime by receiving notification of an offline production printer in real time, obtaining information diagnosing the problem, and then ordering service and/or replacement parts.

Furthermore, the customer does not have to directly request the service report. In an exemplary embodiment, the selection of the place a service request link may automatically request and obtain the printer service report without the customer even knowing that such a report was obtained from the production printer and transmitted along with the service request.

Not every error will require a service request. The app may obtain a status from the various sensors in the production printer, and then may make a subsequent request for the service report if further detail and information is needed. For example, the computing device with the app may obtain a notification that the error is a paper jam and the customer can address paper jam errors on their own. However, mechanical failure, for example, may not be addressed by the customer, and customer may then instruct the production printer to prepare the printer service report.

The my printers menu may also provide a link to the operator manual for the production printer. The operator manual may be stored locally on the customer's computing device so the customer may access the operator manual without Internet connectivity. However, the app may provide a link to the operator manual on the Internet, which may advantageously provide the user with the most up-to-date information. The operator manual may be in PDF format. However, other file formats may be used.

The my printers menus may also provide a link to a training material in the form of an audio and/or video file. The audio and/or video files may be stored locally on the computing device or accessed through the Internet. This training material may walk the customer through troubleshooting and parts-replacement procedures for printer components that may be replaced by the customer. With this training material being provided by the app, the customer may reference the training material directly on their computing device.

In one example, the customer may monitor the operation of their production printer on their mobile device (i.e., cell phone or tablet computer). The customer may determine that an error has occurred, and be provided with detailed description of the error from the production printer. The customer may then access audio and/or video training material, and with their mobile device on the floor by the production printer, proceed to follow the instructions on how to repair the production printer. Thus, some service requests may be skipped, repairs made immediately after an error is detected, and downtime of the production printer minimized. Reduced downtime may lead to higher profits for the customer.

The my printers menu may also provide a link to a media guide. Production printers operate optimally with tested approved media (i.e., approved paper type). Variations in temperature, pressure, speed, and other variables can mean the difference between a satisfied customer and an unsatisfied customer. The provider of the app and the production printer may maintain an updated guide that provides the optimum settings for each production printer for the various media that may be used in the production printer. The app, through the my printers menus, may provide a link to a website that includes this updated guide in XML format. This provides the customer with the most up-to-date settings for optimum use of the production printer, or assists the customer in determining the optimum media for their particular application.

My Services

The my services button 514 may provide the user with the ability to track their print shop business in real time. Print jobs may be submitted to a print shop through web site on a Web to Printer (W2P) server. Software, such as Adobe Scene 7, may be used in conjunction with appropriate hardware for providing the W2P server with the order. The app may interface the customer's computing device with the W2P server in order to obtain real time metrics regarding incoming orders. Furthermore, the app may interface the customer's computing device to the production printers in the print shop so the customer may obtain real time metrics regarding the status of print jobs, and the amount particular machines are being used (i.e., operating time, non-operational time, and/or idle time). Furthermore, the app may interface with the print shop's inventory, which provides the customer with real time inventory levels. This inventory feature may be used in conjunction with the order supplies feature in the my printing menu. Furthermore, the app may obtain metrics regarding print jobs received per day, print jobs completed, print jobs in progress, print jobs not yet started. The app may format the raw data into graphs, charts, and/or detailed reports, as shown FIG. 10.

The app, through the my services functionality, may allow the customer to obtain data regarding the effectiveness of campaigns. U.S. patent application Ser. No. 13/161,094, filed Jun. 15, 2011, describes using QR codes to track campaign effectiveness. The metrics obtain by reference to the QR codes may be provide to or accessed by the app described herein. U.S. patent application Ser. No. 13/161,094 is hereby incorporated by reference in its entirety.

Obviously, numerous modifications and variations of the embodiments described herein are possible in light of the above teachings. It is therefore to be understood that within the scope of the appended claims, the invention may be practiced otherwise than as specifically described herein.

1. A non-transitory computer readable storage medium encoded with instructions, which when executed by a computer causes the computer to implement a method comprising:
generating a first graphical user interface providing links to content stored locally on the computer and to content accessed via Internet; and
generating a second graphical user interface that identifies a printer that the computer is configured to communicate with and obtain diagnostic information from, and that provides links to an interface for ordering parts or supplies for the printer and an interface to place a service request for the printer.

2. The non-transitory computer readable storage medium of claim 1, wherein the computer is a cell phone or a tablet computer.

3. The non-transitory computer readable storage medium of claim 1, wherein the method further comprises:
initiating communication with a controller within the printer;
transmitting an instruction to the controller, which when executed by the controller, causes the controller to generate a printer service report; and
receiving the printer service report from the controller.

4. The non-transitory computer readable storage medium of claim 3, wherein the method further comprises:
transmitting the service request for the printer along with the printer service report.

5. The non-transitory computer readable storage medium of claim 1, wherein the method further comprises:
adding links to the first graphical user interface that connect to content stored locally on the computer.

6. The non-transitory computer readable storage medium of claim 1, wherein the method further comprises:
adding the printer to a database identify which printers the computer is configured to communicate with by receiving a serial number of the printer and an IP address of the printer.

7. The non-transitory computer readable storage medium of claim 1, wherein the second graphical user interface provides a link to a media guide the provides optimum settings for the printer to use with different media.

8. The non-transitory computer readable storage medium of claim 7, wherein the second graphical user interface provides a link to audio, video, or audio-video content providing instruction on how to service the printer.

9. The non-transitory computer readable storage medium of claim 4, wherein the method further comprises:
receiving, in response to the transmitting of the service request, a link to audio, video, or audio-video content providing instruction on how to service the printer.

10. The non-transitory computer readable storage medium of claim 1, wherein the method further comprises:
providing metrics regarding operation of the printer.

11. The non-transitory computer readable storage medium of claim 10, wherein the providing further comprises:
providing metrics regarding inventory in a print shop including the printer; and
providing metrics regarding print jobs submitted to the print shop including the printer.

12. The non-transitory computer readable storage medium of claim 1, wherein the printer is a production printer.

13. A method comprising:
generating, by computer, a first graphical user interface providing links to content stored locally on the computer and to content accessed via Internet; and
generating, by the computer, a second graphical user interface that identifies a printer that the computer is configured to communicate with and obtain diagnostic information from, and that provides links to an interface for ordering parts or supplies for the printer and an interface to place a service request for the printer.

14. An apparatus comprising:
a memory that stores computer executable instructions; and
a processor configured to execute the instructions in order to
generate a first graphical user interface providing links to content stored locally on the apparatus and to content accessed via Internet, and
generate a second graphical user interface that identifies a printer that the computer is configured to communicate with and obtain diagnostic information from, and that provides links to an interface for ordering parts or supplies for the printer and an interface to place a service request for the printer.
